(19) United States
(12) Patent Application Publication
(10) Pub. No.: US 2013/0254088 A1
(43) Pub. Date: Sep. 26, 2013

(54) Computer-Based Systems and Methods for Efficiently Trading Bundles of Volatility Instruments

(71) Applicant: CTC TRADING GROUP, LLC, Chicago, IL (US)

(72) Inventor: Jon Grodnick, Chicago, IL (US)

(73) Assignee: CTC TRADING GROUP, LLC, Chicago, IL (US)

(21) Appl. No.: 13/740,736

(22) Filed: Jan. 14, 2013

Related U.S. Application Data
(60) Provisional application No. 61/585,955, filed on Jan. 12, 2012.

(51) Int. Cl. G06Q 40/04

(52) U.S. Cl. CPC G06Q 40/04
USPC 705/37

(57) ABSTRACT

Computer-implemented system, method and apparatus for constructing and executing a realized volatility bundle representing a bundle of daily realized volatility futures contracts for a set term (e.g., monthly, quarterly, yearly, etc.) or combination of dates (i.e. unemployment, earnings dates, election results, etc.). A full term is set for a transaction to fully execute, where the term is bundled into a plurality of sub-terms having a shorter period than the full term. During execution, a portion of the transaction is realized market-to-market according to each sub-term, until the full term is reached.

### TECHNICAL FIELD

The present disclosure relates to computer-based systems and methods for configuring a computer trading system to process and bundle financial instruments, such as futures contracts, in a manner that allows the bundled instrument to be partially realized in multiple increments.

### BACKGROUND INFORMATION

It is known in the art that a futures contract is a standardized contract between two parties to exchange a specified asset of standardized quantity and quality for a price agreed today (the futures price or the strike price) with delivery occurring at a specified future date, the delivery date. The underlying asset to a futures contract may be varied and can include currencies, securities or financial instruments and intangible assets or referenced items such as stock indexes and interest rates. A derivative instrument is a contract between two parties that specifies conditions—in particular, dates and the resulting values of the underlying variables—under which payments, or payoffs, are to be made between the parties.

Generally, there are two groups of derivative contracts, which are distinguished by the way they are traded in the market: Over-the-counter (OTC) derivatives and Exchange-traded derivative contracts (ETD). OTC derivatives are contracts that are traded (and privately negotiated) directly between two parties, without going through an exchange or other intermediary. Conversely, ETD are derivatives instruments that are traded via specialized derivatives exchanges or other exchanges. A derivatives exchange is a market where individuals trade standardized contracts that have been defined by the exchange. A derivatives exchange acts as an intermediary to all related transactions, and takes initial margin from both sides of the trade to act as a guarantee.

A variance swap is an over-the-counter financial derivative that allows one to speculate on or hedge risks associated with the magnitude of movement, i.e. volatility, of some underlying product, like an exchange rate, interest rate, or stock index. During execution, one leg of the swap will pay an amount based upon the realized variance of the price changes of the underlying product. Conventionally, these price changes will be daily log returns, based upon the most commonly used closing price. The other leg of the swap will pay a fixed amount, which is the strike, quoted at the deal's inception. Thus the net payoff to the counterparties will be the difference between these two and will be settled in cash at the expiration of the deal.

An exemplary financial product with similar characteristics to a variance swap that has gained substantial popularity is the Volatility Index (VIX®) that is based on the implied volatility of S&P 500 index (SPX) options, and represents one measure of the market's expectation of stock market volatility over a given (30 day) time period. Variance swaps in this area are popular OTC contracts that settle to realized SPX volatility. They are typically quoted in volume prices, vega quantities, and pay convex (variance) returns. Replicating this contract with a listed future has proven to be difficult. Conventionally, a variance future results in an instrument that is may be considered equivalent to an OTC contract. However, it has unconventional quoting requirements: (a) it is quoted in variance terms (vol squared) rather than familiar volatility, terms; (b) it is not quoted in vega terms (i.e., derivative of the option value with respect to the volatility of the underlying asset); (c) it contains forward- and backward-looking components, since realized history is embedded into the price, making it difficult to understand what the price implies regarding the future. These conventions have made variance futures unpopular, resulting in minimal usage, despite that fact that it is economically equivalent to an OTC VAR swap which has significant usage in the industry.

Accordingly, there is a need in the art for a computer system that provides transparent, point-and-click market representations for realized volatility, where quotes may be provided in volatility prices, and contains no backward-looking component.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a computer system utilized for executing variance swaps and other transactions under one exemplary embodiment;

FIG. 2A illustrates a trading structure configured to be executed by a computer processor using the system of FIG. 1; and

FIG. 2B is a continuation of the trading structure illustrated in FIG. 2A.

### DETAILED DESCRIPTION

Under one embodiment, a computer system configured to construct and execute a realized volatility “bundle.” The realized volatility bundle represents a bundle of daily realized volatility futures contracts for a set term (e.g., monthly, quarterly, yearly, etc.) or combination of dates (i.e. unemployment, earnings dates, election results, etc.). The packaging and use of this future could be based upon any number of variations, highlighting days with important significance or to highlight specific economic/news events. An exchange could also list vol bundles which settle to other statistical measures of realized vol: Garman Klass, high-low, realized returns calculated every 10 minutes, and so on.

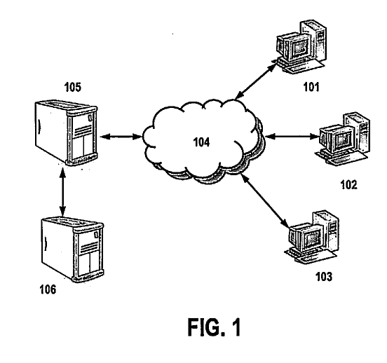

FIG. 1 illustrates an exemplary computer system that may be embodied as an electronic trading system. According to a preferred embodiment, trading system 100, depicted in FIG. 1, is comprised of a trading platform 105 that receives price feeds from 106. Trades occurring on either the OTC exchange or the futures exchange are reported to the trading platform 105 so that a user has access to a single platform for trading both OTC and futures or options contracts. Individual users 101, 102, 103 are electronically linked to the trading platform 105 via a network, such as the internet, 104.

In one example, multiple contracts may be bundled as a single contract, where the bundles are purchased for one uniform set of daily prices, and with each daily contract settling at the market close or at the market or realized value of the contract. The remaining contracts in the bundle are marked-to-market at the realized value and will settle on a daily basis until the remainder of contracts expire or are realized. Daily realized volatility bundles may be traded or sold at market rates with losses or gains based upon the initial daily bundle purchase price. In one advantageous embodiment, valuation and pricing adjustment of daily bundles for overlapping terms (e.g., between one period of time and another) may be addressed by setting the price for the additional term of purchased daily bundles by averaging the set daily bundle price with the new purchase price for the extended term to equal the current market or trading value of the revised daily bundle term.

Some advantageous benefits of a daily realized volatility bundle are: (a) a contract settles to close using determined realized volatility of a daily contract, rather than settling to a combination of realized and implied volatility valuations, (b) payouts are convex or linear, (c) a contract may be quoted in familiar volatility terms, and (d) a contract has no backward-looking feature that requires recognition of realized and implied volatility components. Such advantages not only simplify the formation of a trading position, but further improves the efficiency of a computer system executing the software.

Traditionally, products listed in this arena include both realized and implied components in the valuation and pricing of the product. In this case, a trader operating the software is required to include both the realized history and implied valuation in a bid/offer calculation before entering the market which in turn slows down pricing decisions and limits trading and value of the product to the marketplace. There have been previous attempts to restructure this product to eliminate its complexity and bulkiness. One of many ideas included paying a daily dividend to eliminate the backward looking (or realized) component. Unfortunately, restructuring the product is difficult due to regulation and operational practicality.

Accordingly, the realized volatility bundle disclosed herein overcomes many of these issues and provides an efficient method for computer system trading. An exemplary process for forming and trading a realized volatility bundle is described below:
(1) Customer buys December 2011 bundle for price of 26. The bundle is configured to expire after 90 trading days until expiration.
(2) As a result of (1), customer is delivered 90, 1-day realized vol futures, all at a price of 26.
   (a) The first daily future would settle to the current day's close-close realized vol,
   (b) The second daily future expires to the following day's realized vol,
   (c) The third daily future expires the day after that, and so on.
(3) Each day, one future expires. Thus, under the example, the customer makes/loses the difference between the original 26 “buy” price and the realized settlement. Returns could be calculated convex or linear. Under a preferred embodiment, convex returns are used since this would ensure volatiliy trades at prices similar to the implied volatility for standard options and var swaps.
(4) The bundle continues to trade until December expiration and is marked-to-market based upon current trade. New bundle quotes are always made for the remaining contracts, and require no knowledge of how the previous futures settled.
(5) Margin requirements for the 90, 1-day realized volatility futures bundle would go down each day as daily futures expire and settle.

Thus, under the example given above, if a bundle was sold on day 3 at 28, the next 60, 1-day realized vol futures, each daily contract in the bundle would be priced at 29 taking the average of the price for the current term and the price to be set for the future term based upon market valuation.

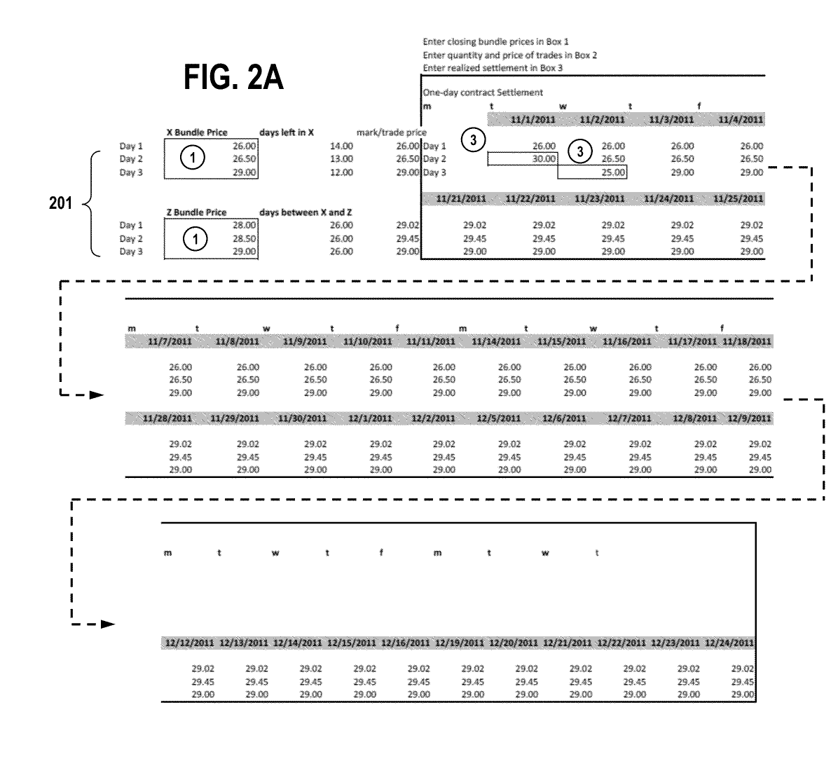

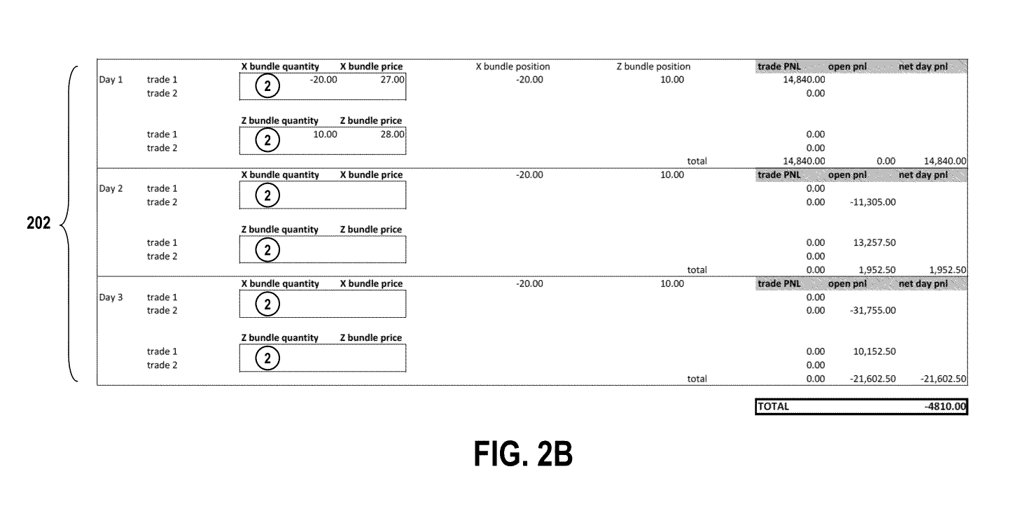

Turning to FIGS. 2A-B, an exemplary algorithmic chart is provided, illustrating the process of volatility bundles purchase for two periods, designated as “X” and “Z” in 201. For this example, X will designate the month of November, while Y designates the month of December. Each period has a specific term (e.g., 21 days), and together make up the full term of the bundle. Thus in one example of FIGS. 2A-B, on November 1, Customer A buys November bundle for price of 26 and sells it later that day at 26.5. After buying the contract for 26, customer is delivered 21 one-day realized vol contracts (one for each trading day of the month). Later, all the contracts are sold at 26.5 earning a squared payout (or linear payout if structured that way) of 0.5 vol point on 21 contracts.

In another example, on November 1, Customer B buys the November bundle for price of 26. The November 1st contract expires that day to realized vol of 30. The November bundle settles at 26.5 (e.g., last trade price, end of day mid-market value, etc.). Customer B makes 4 vol points on the November 1 contract which just expired. Customer B also makes .5 vol point on mark to market on the remaining 20 contracts. In other words, all remaining contracts are marked daily to the end of day bundle price. The next day, Customer B sells the bundle at 23. Here he loses 3.5 vol points from the previous mark to market value of 26.5 on the remaining contracts that have not expired.

In yet another example, on November 1, Customer C buys the December Bundle (also 42 trading days) for 28. That day, the November bundle closes at 26 and December bundle closes at 28. Here, the customer would receive 42 one-day realized vol contracts (one for each trading day). The days in November would be delivered to him at 26 (the current November bundle price). The days in December would be delivered by solving for the price that averages a 28 payout over 42 days. In this case, the days in December would settle at about 30, based on the following equation:

CP=Xₚ*D_{X}+Zₚ*D_{Z}/DT_{Z}

Where CP represents the current price of the December bundle, X, is the current November bundle price, D_{X} is the number of trading days in the November term, Zₚ is the price of the December contracts , D_{Z} is the number of trading days in December, and DT_{Z} is the total number trading days for the November bundle. Accordingly,

(26)*(21)+(X)*(21)/(42)=28

Daily settlement of all non-expired contracts would follow the same procedure. All non-expired daily contracts in November are marked to the November Bundle closing price. All contract in December marked to ensure that the average price/contract=the December Bundle closing price.

In section 202 of FIG. 2A, customers can immediately determine returns based on specific values for bundles. Here, bundle quantity and bundle price is entered for each of terms X and Z. In this example, on day 1, a customer sells 20 X bundles at a price of 27, where the closing bundle price is 26 (from 201). Also, customer buys 10 Z bundles at 28 where the closing Z bundle price is 28 (from 201). The customer positions can be immediately processed and calculated. As can be seen, on the first day the customer makes s profit (PNL) of $14,840. On the next day, the X bundle loses $11,205.00 (based on closing price of $26.50), while the Z bundle makes a profit of $13,257.00 based on the Z closing bundle price for that day ($28.50). This results in a net day profit of $1,952.50 for day 2. On day 3 (again, assuming no further trading is done), the X bundle closes at 29, resulting in a further loss of $31,755.00. In the meantime, the Z bundle closes at 29 resulting in a profit of $10,152.50. Together, the X and Z bundles produce a net day loss of $21,602.50. Continuing this throughout the full term (e.g., 42 days), it can be seen that the total PNL for the X and Z bundles is $4,810.00.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

What is claimed is:

1. A computer-implemented method for performing executing a transaction, comprising the steps of:
setting a full term for the transaction to fully execute;
bundling the term into a plurality of sub-terms having a shorter period than the full term; and
realizing a portion of the transaction market-to-market according to each sub-term until the full term is reached.
